(19) United States
(12) Patent Application Publication
(10) Pub. No.: US 2008/0048348 A1
(43) Pub. Date: Feb. 28, 2008

(54) CIRCULATION WATER VORTEX BUBBLE GENERATION DEVICE FOR AQUACULTURE POND

(76) Inventor: Shung-Chi Kung, Ping Tung Hsien (TW)

Correspondence Address: LEONG C LEI, PMB # 1008, 1867 YGNACIO VALLEY ROAD, WALNUT CREEK, CA, 94598, US

(21) Appl. No.: 11/456,570

(22) Filed: Jul. 11, 2006

(51) Int. Cl. B01F 3/04

(52) U.S. Cl. 261/76; 261/79.2; 261/123; 261/DIG. 75

(57) ABSTRACT

A circulation water vortex bubble generation device is emerged in culture water of an aquaculture pond. The device includes a barrel having a central bore and front and rear open ends, a cover attached to the rear end of the barrel, and a nozzle mounted to the front end of the barrel. A water supply pipe is connected to the barrel in an off-center manner to supply water into the central bore. An air pipe is connected to the cover and in fluid communication with an air chamber defined inside the cover. An air guide tube in fluid communication with the air chamber extends from the cover through the central bore of the barrel. The nozzle forms a rearward-diverging conic water guide opening in a rear portion thereof, and in communication with the central bore. The nozzle also forms a water discharge opening in a front portion thereof and a water passage connecting between the water guide opening and the water discharge opening. A rearward-diverging mouth joints between the water guide opening and the water passage and receive a free open end of the air guide tube therein. Pressurized water is supplied through the water supply pipe into the barrel to circulate in the form of a vortex inside fee barrel and then discharged by the nozzle into the culture water. A free end of the air pipe is arranged above a surface of the culture water to guide air into the barrel and mixed with the circulating water and discharged into the culture to form tiny bubbles, which bring impurity and protein contained in the culture water to the surface of the culture water for separation of the impurity and increase oxygen content of the culture water.

### BACKGROUND OF THE INVENTION

(a) Technical Field of the Invention

The present invention relates generally to a circulation water vortex bubble generation device, and in particular to a device that discharges pressurized water in a vortex form to generate tiny bubbles for effectively separating impurity and protein contained in water of an aquaculture pond and to increase oxygen content of the culture water.

(b) Description of the Prior Art

Water quality and oxygen content of water are important factors for survival rate of pond aquaculture. Thus, in the aquacultivation business, control of water quality and increase of oxygen content of water are severe challenges to increase survival rate of fishes or she likes.

A conventional way to maintain water quality of a culture pond is to continuously pump fresh water into the pond and thus replace used water of the pond by the fresh water, which constantly keeps the pond water in a partly replaced condition to control, at least to some extents, contamination of the culture water by for example fish feeds, excreta, and oilier impurity, or variation of water quality caused by external, factors, such as weather. As to oxygen content, a water wheel is employed to induce water flow in the culture pond. Alternatively pipes are arranged on the bottom of the culture pond and air is driven into the pipes for generation of hubbies in foe culture water, to enhance content of oxygen in the culture water.

However, the conventional ways of maintaining water quality and increasing oxygen content of culture water are expensive in installing related, facility and piping. In addition, running costs are also very high for those facility must be in operation for all day long, which consumes a great amount of electrical power. Briefly speaking, foe conventional ways are very costly for foe aquaculture business and may affect market competition for the aquaculture products. An additional drawback is that: a great amount of fresh water must be consumed in maintaining water quality by replacing water, which simply wastes valuable and limited water resources of our environment. Some of foe replacing water is obtained from underground water, and overdrawing underground water may lead to sinking of ground.

### SUMMARY OF THE INVENTION

The primary purpose of the present invention is to provide a circulation water vortex bubble generation device, by which pressurized circulation water is discharged into a culture pond in a vortex form, and a plurality of tiny bubbles is generated and entraining the discharged water, whereby impurity and protein, contained in the water of the culture pond are effectively separated and removed, and oxygen content of the culture water is enhanced. The device is of low costs and reduces power consumption and saves valuable ware resources.

The foregoing object and summary provide only a brief introduction to the present invention. To fully appreciate these and other objects of the present invention as well as the invention itself all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed, in the art upon making reference to the detailed description and the accompanying sheets of drawings in which a preferred structural embodiment incorporating the principles of tire present invention is shown by way of illustrative example.

### BRIEF DESCRIPTION OF THE DRAWINGS

The present invention will be apparent to those skilled in the at by reading the following description of a preferred embodiment thereof with reference to the attached drawings, in which:

FIG. 1 is a perspective view of a circulation water vortex, bubble generation device constructed in accordance with the present invention;

FIG. 2 is a cross-sectional view of the circulation water vortex bubble generation, device of the present invention; and

FIG. 3 is a schematic side elevational view showing the operation of the circulation water vortex generation device of the present invention in a culture pond.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

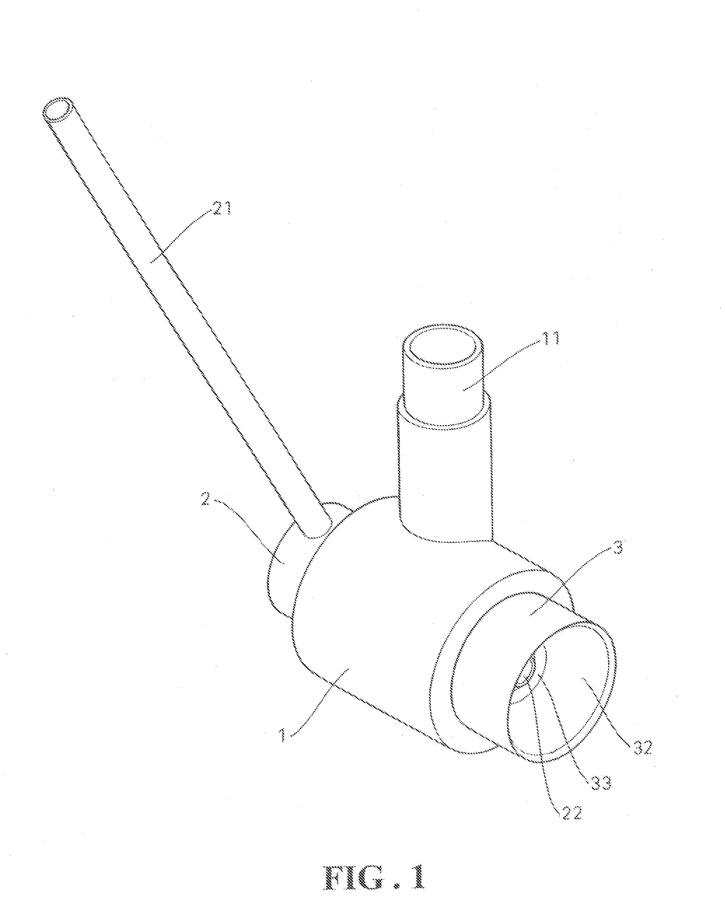

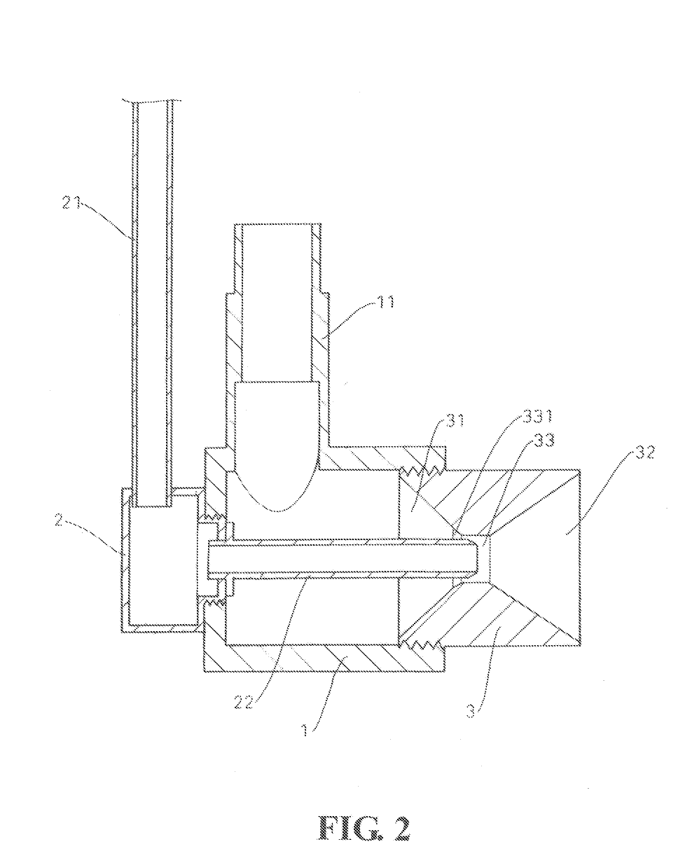

With reference to the drawings and in particular to FIGS. 1 and 2, a circulation water vortex, bubble generation device constructed in accordance with the present invention comprises a barrel 1 having opposite rear and font open ends to which a cover 2 and a nozzle 3 are respectively mounted. The barrel 1 is a cylindrical body with a central bore extending completely therethrough in an axial direction between the opposite open ends. A water supply pipe 11, extending in a direction, substantially normal to the axis of the barrel 1, is connected to an outer circumference of the barrel 1 in a tangential or off-center manner and in fluid communication with the central bore of the barrel 1. The water supply pipe 11 supplies pressurized water into the barrel 1 and causes the supplied pressurized water to circulate along the cylindrical inner wall of the barrel 1 by means of the tangential connection between the water supply pipe 11 and the barrel 1, whereby vortex is induced inside the barrel 1.

The cover 2 is a hollow body, which defines an interior space serving as an air chamber. The cover 2 is attached to the rear open end of the barrel 1 by any known means, such as threading coupling as shown in the drawings. An air pipe 21 is connected to rite cover and in communication with the air chamber of the cover 2 by having an open end of the air pipe 21 extending into the air chamber of the cover 2. The cover 2 forms an air guide tube 22 extending from an inside surface thereof which is located inside the barrel 1, through the central bore of the barrel 1 with a free open end of the air guide tube 22 projecting into the nozzle 3 attached to the front open end of the barrel 1. The air guide tube 22 is in fluid communication, with the air chamber of the cover 2 to guide air from the air chamber of the cover 2 to the nozzle 3, which will be further discussed.

The air guide tube 22 is of an outside diameter substantially smaller titan inside diameter of the central bore of the barrel 1 whereby a sufficient circumferential space is delimited between the inside diameter of the central bore of the barrel 1 and the air guide tube 22 for the vortex generated by pressurized water supplied from the water supply pipe 11.

The nozzle 3 is attached to the front open end of the barrel 1 in an axially movable manner, such as by means of threading coupling. In other words, the relative position of the nozzle 3 with respect to the front open end of the barrel 1 can be changed by moving the nozzle 3 in the axial direction with respect to the barrel 1, and in the embodiment illustrated, this is done by rotation of the nozzle 3 with respect to the barrel 1.

The nozzle 3 forms a water guide opening 31 of a conic configuration that diverges in a rearward direction, that is the direction toward the barrel 1, in a rear portion thereof with foe opening 31 in fluid communication with the central bore of the barrel 1 to guide foe water that circulates inside the barrel 1 into foe nozzle 3. The nozzle 3 also forms a water discharge opening 32 in the form of a frontward-diverging cone in a front portion thereof. A water passage 33 of a suitable diameter, which, makes the water passage 33 a neck between the reduced ends of the mar conic opening 31 and the front conic opening 32, is formed in the nozzle 3 and connects between and in fluid communication with the water guide opening 31 and the water discharge opening 32. The connection between the water passage 33 and the water guide opening 31 forms a slightly rearward-diverging mouth 331, which has a slope different, from, preferably smaller than, that of foe cone of the water guide opening 31, for receiving the front open end of the air guide tube 22 into the passage 33, preferably in foe vicinity of the month 331, with a sufficient gap existing between inside surface of the passage 33 (and the mouth 331) and the air guide tube 22 for water to flow therethrough with changes in pressure and speed. The water then flows into the water discharge opening 32 for discharging frontward out of tire nozzle 3.

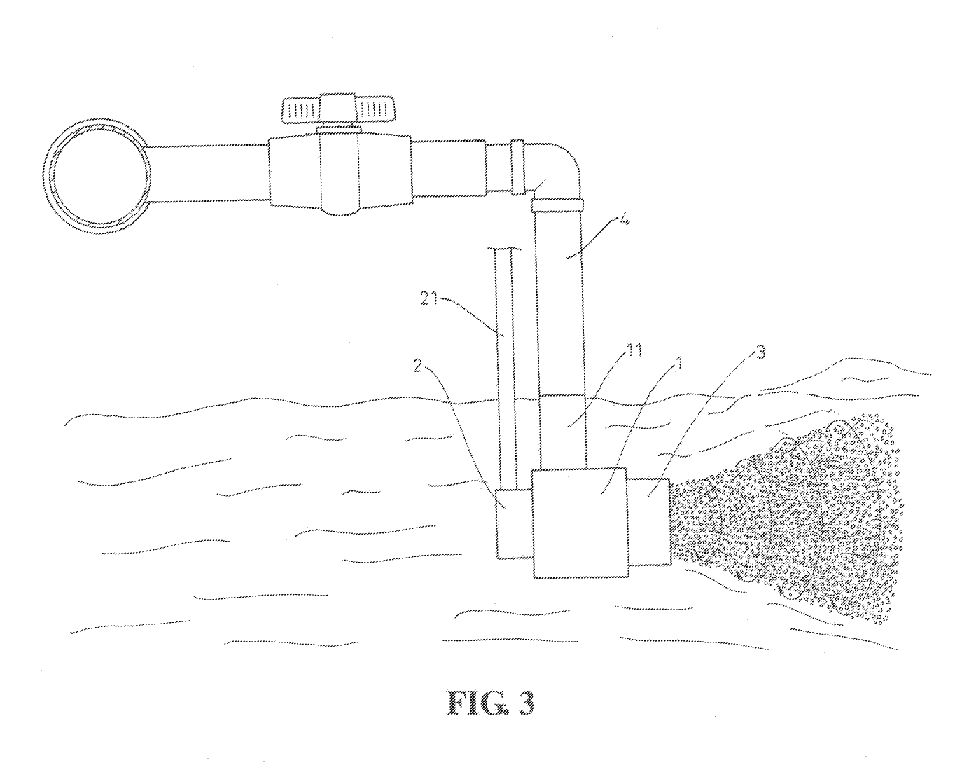

During the discharge of the water through the nozzle 3, the speed increase of the water flow induces a pressure drop, which facilitates drawing air from the air guide tube 22 into the water flowing through fee passage 33, as demonstrated in FIG. 3, whereby the air entrains the water flow and becomes a plurality of tiny bubbles when the water is discharged through the water discharge opening 32.

By rotating the nozzle 3 with respect to the barrel 1 to change the axial position of the nozzle 3 with respect to the barrel 1, the gap between the mount 331 and the air guide tube 22 is adjusted due to the diverging configuration of the mouth 331. This allows adjustment of discharge water pressure of the nozzle 3 on the basis of the water supply pressure by which water is supplied into the barrel 1. FIG. 2 shows the positional relationship between the air guide tube and the mount (or the water passage) when the water supply pressure is minimum. In case of larger water simply pressure, the nozzle can be axially moved outward with respect to the barrel.

FIG. 3 shows the operation of the circulation water vortex bubble generation device of the present invention in culture water. The barrel 1, the cover 2, and the nozzle 3 of the circulation water vortex bubble generation device are completely merged in the culture water. The water supply pipe 11 is connected to main water conveyance pipe 4, through which pressurized water is supplied into the barrel 1. A free end of the air pipe 21 is arranged beyond the water surface to form communication with the air chamber of the cover 2 and the surrounding atmosphere. When pressurized water is filled into the barrel 1 and circulates along the inside surface of the central bore of the barrel 1 to form, a vortex and flows through the gap between the air guide tube 22 and the mount 331 (and the water passage 33) to discharge through the water discharge opening 32 of the nozzle 3 into the culture water. The discharge of the circulating water induces a pressure drop that: draws air through the air pipe 21, the air chamber of the cover 2, and the air guide tube 22, into the water flowing through the nozzle 3. The air is mixed with the circulating water and entrains the circulating water into the culture water by which the air becomes a plurality of tiny bubbles moving with the circulating water in the form of a vortex that stir the culture water and thus causes impurity and protein contained in the culture water to move upward with the air bubbles and floating on the water surface, thereby realizing separation of the impurity. The air bubbles also facilitate increase oxygen content in the culture water. Thus, control of water quality and increase of oxygen content can be realized simultaneously.

The present invention features circulation of pressurized water supplied into fee barrel 1 through the water supply pipe 11 in a tangential or off-center manner to form a circulating vortex that moves into the nozzle 3 through the water guide opening 31, passing through the gap between the air guide tube 22 and the mouth 331 (and the water passage 33), and then discharged through the water discharge opening 32, together with drawing air in through the air guide tube 22 to generate a plurality of tiny air bubbles, which bring impurity and protein, contained in the culture water to the water surface for effective separation of the impurity and protein from the culture water and thus realize control of water quality and increase of oxygen content.

Further, the present invention can be embodied with simple water pumping/pressurizing facility and conveyance piping. Installation costs are low and power consumption is reduced. Moreover, the present invention can be practiced by circulating culture water of an aquaculture pond so that replenishment of fresh water is minimized, which helps conserve water resources. All these demonstrate the benefits of the present invention.

In addition, the present invention allows for adjustment of discharge water pressure and flow rate on the basis of the water supply pressure, which is the pressure of the water supplied into the barrel of the circulation water vortex bubble generation bubble generation device of the present invention. The adjustment is done with axial displacement of the nozzle 3 with respect to the barrel 1 to change the gap size between the air guide tube 22 and the mouth 331 (or the passage 33) thereby changing the pressure and flow rate of the water discharged through the device of fee present invention in order to meet requirements for different applications.

Other modification can also be done within the scope of the present invention. For example, besides a conic shape, the water discharge opening 32 can be made other configurations, such as a straight tube, and the length can be modified, if necessary, to suit for culture ponds of different sizes and shapes.

If required, gases, such as oxygen gas, can be directly supplied into the air pipe 21 to suit the needs of different aquacultures.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A circulation water vortex bubble generation, device adapted to operate in culture water of an aquaculture pond, the device comprising a barrel having a central bore and front, and mar open ends, a cover attached to the rear end of the barrel, and a nozzle mounted to the front end of the barrel, a water supply pipe connected to the barrel in an off-center manner and in fluid, communication with the central bore to supply water into the central bore, an air pipe connected to the cover and in fluid communication with an air chamber defined inside the cover, an air guide tube in fluid communication with the air chamber and extending from the cover through tire central bore of the barrel, the nozzle forming a water guide opening in a rear portion, thereof the water guide opening being of a conic shape that diverges in a rearward direction and in communication with the central bore, the nozzle further forming a water discharge opening in a front portion thereof, a water passage connecting between and in fluid communication with the water guide opening and the water discharge opening, a rearward-diverging mouth being formed between the water guide opening and the water passage to receive a free open end of the air guide tube therein, wherein pressurized water is supplied through the water supply pipe into the barrel to circulate in the form of a vortex inside the barrel and then discharged by the nozzle into the culture water, and a tree end of the air pipe is arranged above a surface of the culture water to guide air into the barrel and mixed with the circulating water and discharged into the culture to form tiny bubbles, which bring impurity and protein contained, in the culture water to the surface of the culture water for separation of the impurity and increase oxygen content of the culture water.

2. The circulation water vortex bubble generation device as claimed in claim 1, wherein the nozzle is position-adjustable with respect to the barrel to adjust size of a gap between the air guide tube and the mouth so as to adjust pressure and flow rate of the water discharged by the nozzle.

3. The circulation water vortex bubble generation device as claimed in claim 1, wherein the water discharge opening is of a conic shape.

4. The circulation water vortex bubble generation device as claimed in claim 1, wherein the water discharge opening comprises a straight tube.
